(19) United States
(12) Patent Application Publication
(10) Pub. No.: US 2022/0180699 A1
(43) Pub. Date: Jun. 9, 2022

(54) METHOD OF USING MULTIPLE DATA TYPES TO CALCULATE ODDS

(71) Applicant: AdrenalineIP, Washington, DC (US)

(72) Inventors: Casey Alexander HUKE, Washington, DC (US); John CRONIN, Jericho, VT (US); Joseph W. BEYERS, Saratoga, CA (US); Michael D'ANDREA, Burlington, VT (US)

(73) Assignee: AdrenalineIP, Washington, DC (US)

(21) Appl. No.: 17/395,729

(22) Filed: Aug. 6, 2021

Related U.S. Application Data
(60) Provisional application No. 63/123,042, filed on Dec. 9, 2020.

(51) Int. Cl. G07F 17/32; G06Q 50/34

(52) U.S. Cl. CPC G07F 17/3225; G06Q 50/34; G07F 17/3288

(57) ABSTRACT

The present disclosure provides a method for using multiple data types to calculate odds on a wagering network which collects a plurality of data sources from a live event from a game or a match and determines if the data source meets the requirements of the wagering network by comparing the parameters of the data source to the requirements of the wagering network to determine if the data source contains the necessary information to calculate odds for the wagering network.

### CROSS-REFERENCE TO RELATED APPLICATIONS

The present patent application claims benefit and priority to U.S. Provisional Patent Application No. 63/123,042 entitled “AI MULTI DATA TYPE ODDS” filed on Dec. 9, 2020, which is hereby incorporated by reference into the present disclosure.

### FIELD

The present disclosures are generally related to play-by-play wagering on live sporting events.

### BACKGROUND

Currently, an issue with wagering platforms or wagering applications is that the odds are created from only one data source.

Also, problems may occur when the data source sends incorrect or inaccurate information from a live event, such as an incorrect score or time remaining, incorrect players, etc.

Lastly, there is currently no solution to allow wagering platforms to switch or alter the data sources used to calculate odds.

Thus, there is a need in the prior art to provide the ability to change or switch the data source based on the demands of a wagering platform.

### SUMMARY

Methods, systems, and apparatuses for using multiple data types to calculate odds on a wagering network. In one embodiment, the a method of utilizing multiple data sources to calculate odds on a wagering network includes collecting at least one data source from at least one sensor in a live event; storing the data source and at least one data parameter in a data source database; offering a data threshold database comprising a list of at least one data threshold requirement; comparing at least one of the data source parameters in the data source database to at least one of the threshold requirements in the data threshold database; determining if the data source meets or exceeds the threshold requirements; and sending the data source to an odds calculation module.

In another embodiment, a system of utilizing multiple data sources to calculate odds on a wagering network can include a base module; a data source module; and a source threshold module, wherein the base module is configured to initiate at least a data source module and a source threshold module; the data source module is configured to connect to a live event, receive at least one data source from the live event, and store the data source in a data source database; the source threshold module is configured to extract at least one data source from the data source database, compare the data source to at least one threshold listed in a data threshold database, and send the data source to an odds calculation module; the data source database configured to contain at least one data source from the live event, source number, type of event, source identification, type of data source, player parameter, score parameter, and time parameter; and the data threshold database is configured to contain at least one of a threshold, type of event, and requirement for the data source.

### BRIEF DESCRIPTIONS OF THE DRAWINGS

The accompanying drawings illustrate various embodiments of systems, methods, and various other aspects of the embodiments. Any person with ordinary art skills will appreciate that the illustrated element boundaries (e.g., boxes, groups of boxes, or other shapes) in the figures represent an example of the boundaries. It may be understood that, in some examples, one element may be designed as multiple elements or that multiple elements may be designed as one element. In some examples, an element shown as an internal component of one element may be implemented as an external component in another and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1: illustrates a system for using multiple data types to calculate odds, according to an embodiment.

FIG. 2: illustrates a base module, according to an embodiment.

FIG. 3: illustrates a data source module, according to an embodiment.

FIG. 4: illustrates a source threshold module, according to an embodiment.

FIG. 5: illustrates a data source database, according to an embodiment.

FIG. 6: illustrates a data threshold database, according to an embodiment.

### DETAILED DESCRIPTION

Aspects of the present invention are disclosed in the following description and related figures directed to specific embodiments of the invention. Those of ordinary skill in the art will recognize that alternate embodiments may be devised without departing from the spirit or the scope of the claims. Additionally, well-known elements of exemplary embodiments of the invention will not be described in detail or will be omitted so as not to obscure the relevant details of the invention.

As used herein, the word exemplary means serving as an example, instance or illustration. The embodiments described herein are not limiting, but rather are exemplary only. The described embodiments are not necessarily to be construed as preferred or advantageous over other embodiments. Moreover, the terms embodiments of the invention, embodiments, or invention do not require that all embodiments of the invention include the discussed feature, advantage, or mode of operation.

Further, many of the embodiments described herein are described in terms of sequences of actions to be performed by, for example, elements of a computing device. It should be recognized by those skilled in the art that specific circuits can perform the various sequence of actions described herein (e.g., application specific integrated circuits (ASICs)) and/or by program instructions executed by at least one processor. Additionally, the sequence of actions described herein can be embodied entirely within any form of computer-readable storage medium such that execution of the sequence of actions enables the processor to perform the functionality described herein. Thus, the various aspects of the present invention may be embodied in several different forms, all of which have been contemplated to be within the scope of the claimed subject matter. In addition, for each of the embodiments described herein, the corresponding form of any such embodiments may be described herein as, for example, a computer configured to perform the described action.

With respect to the embodiments, a summary of terminology used herein is provided.

An action refers to a specific play or specific movement in a sporting event. For example, an action may determine which players were involved during a sporting event. In some embodiments, an action may be a throw, shot, pass, swing, kick, and/or hit performed by a participant in a sporting event. In some embodiments, an action may be a strategic decision made by a participant in the sporting event, such as a player, coach, management, etc. In some embodiments, an action may be a penalty, foul, or other type of infraction occurring in a sporting event. In some embodiments, an action may include the participants of the sporting event. In some embodiments, an action may include beginning events of sporting event, for example opening tips, coin flips, opening pitch, national anthem singers, etc. In some embodiments, a sporting event may be football, hockey, basketball, baseball, golf, tennis, soccer, cricket, rugby, MMA, boxing, swimming, skiing, snowboarding, horse racing, car racing, boat racing, cycling, wrestling, Olympic sport, eSports, etc. Actions can be integrated into the embodiments in a variety of manners.

A “bet” or “wager” is to risk something, usually a sum of money, against someone else's or an entity based on the outcome of a future event, such as the results of a game or event. It may be understood that non-monetary items may be the subject of a “bet” or “wager” as well, such as points or anything else that can be quantified for a “bet” or “wager.” A bettor refers to a person who bets or wagers. A bettor may also be referred to as a user, client, or participant throughout the present invention. A “bet” or “wager” could be made for obtaining or risking a coupon or some enhancements to the sporting event, such as better seats, VIP treatment, etc. A “bet” or “wager” can be made for certain amount or for a future time. A “bet” or “wager” can be made for being able to answer a question correctly. A “bet” or “wager” can be made within a certain period. A “bet” or “wager” can be integrated into the embodiments in a variety of manners.

A “book” or “sportsbook” refers to a physical establishment that accepts bets on the outcome of sporting events. A “book” or “sportsbook” system enables a human working with a computer to interact, according to set of both implicit and explicit rules, in an electronically powered domain to place bets on the outcome of sporting event. An added game refers to an event not part of the typical menu of wagering offerings, often posted as an accommodation to patrons. A “book” or “sportsbook” can be integrated into the embodiments in a variety of manners.

To “buy points” means a player pays an additional price (more money) to receive a half-point or more in the player's favor on a point spread game. Buying points means you can move a point spread, for example, up to two points in your favor. “Buy points” can be integrated into the embodiments in a variety of manners.

The “price” refers to the odds or point spread of an event. To “take the price” means betting the underdog and receiving its advantage in the point spread. “Price” can be integrated into the embodiments in a variety of manners.

“No action” means a wager in which no money is lost or won, and the original bet amount is refunded. “No action” can be integrated into the embodiments in a variety of manners.

The “sides” are the two teams or individuals participating in an event: the underdog and the favorite. The term “favorite” refers to the team considered most likely to win an event or game. The “chalk” refers to a favorite, usually a heavy favorite. Bettors who like to bet big favorites are referred to “chalk eaters” (often a derogatory term). An event or game in which the sportsbook has reduced its betting limits, usually because of weather or the uncertain status of injured players, is referred to as a “circled game.” “Laying the points or price” means betting the favorite by giving up points. The term “dog” or “underdog” refers to the team perceived to be most likely to lose an event or game. A “longshot” also refers to a team perceived to be unlikely to win an event or game. “Sides,” “favorite,” “chalk,” “circled game,” “laying the points price,” “dog,” and “underdog” can be integrated into the embodiments in a variety of manners.

The “money line” refers to the odds expressed in terms of money. With money odds, whenever there is a minus (−), the player “lays” or is “laying” that amount to win (for example, $100); where there is a plus (+), the player wins that amount for every $100 wagered. A “straight bet” refers to an individual wager on a game or event that will be determined by a point spread or money line. The term “straight-up” means winning the game without any regard to the “point spread,” a “money-line” bet. “Money line,” “straight bet,” and “straight-up” can be integrated into the embodiments in a variety of manners.

The “line” refers to the current odds or point spread on a particular event or game. The “point spread” refers to the margin of points in which the favored team must win an event by to “cover the spread.” To “cover” means winning by more than the “point spread.” A handicap of the “point spread” value is given to the favorite team so bettors can choose sides at equal odds. “Cover the spread” means that a favorite wins an event with the handicap considered or the underdog wins with additional points. To “push” refers to when the event or game ends with no winner or loser for wagering purposes, a tie for wagering purposes. A “tie” is a wager in which no money is lost or won because the teams' scores were equal to the number of points in the given “point spread.” The “opening line” means the earliest line posted for a particular sporting event or game. The term “pick” or “pick 'em” refers to a game when neither team is favored in an event or game. “Line,” “cover the spread,” “cover,” “tie,” “pick,” and “pick-em” can be integrated into the embodiments in a variety of manners.

To “middle” means to win both sides of a game; wagering on the “underdog” at one point spread and the favorite at a different point spread and winning both sides. For example, if the player bets the underdog +4½ and the favorite −3½ and the favorite wins by 4, the player has middled the book and won both bets. “Middle” can be integrated into the embodiments in a variety of manners.

Digital gaming refers to any type of electronic environment that can be controlled or manipulated by a human user for entertainment purposes. A system that enables a human and a computer to interact according to set of both implicit and explicit rules in an electronically powered domain for the purpose of recreation or instruction. “eSports” refers to a form of sports competition using video games, or a multiplayer video game played competitively for spectators, typically by professional gamers. Digital gaming and “eSports” can be integrated into the embodiments in a variety of manners.

The term event refers to a form of play, sport, contest, or game, especially one played according to rules and decided by skill, strength, or luck. In some embodiments, an event may be football, hockey, basketball, baseball, golf, tennis, soccer, cricket, rugby, MMA, boxing, swimming, skiing, snowboarding, horse racing, car racing, boat racing, cycling, wrestling, Olympic sport, etc. The event can be integrated into the embodiments in a variety of manners.

The “total” is the combined number of runs, points or goals scored by both teams during the game, including overtime. The “over” refers to a sports bet in which the player wagers that the combined point total of two teams will be more than a specified total. The “under” refers to bets that the total points scored by two teams will be less than a certain figure. “Total,” “over,” and “under” can be integrated into the embodiments in a variety of manners.

A “parlay” is a single bet that links together two or more wagers; to win the bet, the player must win all the wagers in the “parlay.” If the player loses one wager, the player loses the entire bet. However, if they win all the wagers in the “parlay,” the player receives a higher payoff than if the player had placed the bets separately. A “round robin” is a series of parlays. A “teaser” is a type of parlay in which the point spread, or total of each individual play is adjusted. The price of moving the point spread (teasing) is lower payoff odds on winning wagers. “Parlay,” “round robin,” “teaser” can be integrated into the embodiments in a variety of manners.

A “prop bet” or “proposition bet” means a bet that focuses on the outcome of events within a given game. Props are often offered on marquee games of great interest. These include Sunday and Monday night pro football games, various high-profile college football games, major college bowl games, and playoff and championship games. An example of a prop bet is “Which team will score the first touchdown?” “Prop bet” or “proposition bet” can be integrated into the embodiments in a variety of manners.

A “first-half bet” refers to a bet placed on the score in the first half of the event only and only considers the first half of the game or event. The process in which you go about placing this bet is the same process that you would use to place a full game bet, but as previously mentioned, only the first half is important to a first-half bet type of wager. A “half-time bet” refers to a bet placed on scoring in the second half of a game or event only. “First-half-bet” and “half-time-bet” can be integrated into the embodiments in a variety of manners.

A “futures bet” or “future” refers to the odds that are posted well in advance on the winner of major events. Typical future bets are the Pro Football Championship, Collegiate Football Championship, the Pro Basketball Championship, the Collegiate Basketball Championship, and the Pro Baseball Championship. “Futures bet” or “future” can be integrated into the embodiments in a variety of manners.

The “listed pitchers” is specific to a baseball bet placed only if both pitchers scheduled to start a game start. If they do not, the bet is deemed “no action” and refunded. The “run line” in baseball refers to a spread used instead of the money line. “Listed pitchers,” “no action,” and “run line” can be integrated into the embodiments in a variety of manners.

The term “handle” refers to the total amount of bets taken. The term “hold” refers to the percentage the house wins. The term “juice” refers to the bookmaker's commission, most commonly the 11 to 10 bettors lay on straight point spread wagers: also known as “vigorish” or “vig”. The “limit” refers to the maximum amount accepted by the house before the odds and/or point spread are changed. “Off the board” refers to a game in which no bets are being accepted. “Handle,” “juice,” vigorish,” “vig,” and “off the board” can be integrated into the embodiments in a variety of manners.

“Casinos” are a public room or building where gambling games are played. “Racino” is a building complex or grounds having a racetrack and gambling facilities for playing slot machines, blackjack, roulette, etc. “Casino” and “Racino” can be integrated into the embodiments in a variety of manners.

Customers are companies, organizations or individuals that would deploy, for fees, and may be part of, or perform, various system elements or method steps in the embodiments.

Managed service user interface service is a service that can help customers (1) manage third parties, (2) develop the web, (3) perform data analytics, (4) connect thru application program interfaces and (4) track and report on player behaviors. A managed service user interface can be integrated into the embodiments in a variety of manners.

Managed service risk management service are services that assist customers with (1) very important person management, (2) business intelligence, and (3) reporting. These managed service risk management services can be integrated into the embodiments in a variety of manners.

Managed service compliance service is a service that helps customers manage (1) integrity monitoring, (2) play safety, (3) responsible gambling, and (4) customer service assistance. These managed service compliance services can be integrated into the embodiments in a variety of manners.

Managed service pricing and trading service is a service that helps customers with (1) official data feeds, (2) data visualization, and (3) land based on property digital signage. These managed service pricing and trading services can be integrated into the embodiments in a variety of manners.

Managed service and technology platforms are services that help customers with (1) web hosting, (2) IT support, and (3) player account platform support. These managed service and technology platform services can be integrated into the embodiments in a variety of manners.

Managed service and marketing support services are services that help customers (1) acquire and retain clients and users, (2) provide for bonusing options, and (3) develop press release content generation. These managed service and marketing support services can be integrated into the embodiments in a variety of manners.

Payment processing services are services that help customers with (1) account auditing and (2) withdrawal processing to meet standards for speed and accuracy. Further, these services can provide for integration of global and local payment methods. These payment processing services can be integrated into the embodiments in a variety of manners.

Engaging promotions allow customers to treat players to free bets, odds boosts, enhanced access, and flexible cashback to boost lifetime value. Engaging promotions can be integrated into the embodiments in a variety of manners.

“Cash out” or “pay out” or “payout” allow customers to make available, on singles bets or accumulated bets with a partial cash out where each operator can control payouts by always managing commission and availability. The “cash out” or “pay out” or “payout” can be integrated into the embodiments in a variety of manners, including both monetary and non-monetary payouts, such as points, prizes, promotional or discount codes, and the like.

“Customized betting” allows customers to have tailored personalized betting experiences with sophisticated tracking and analysis of players' behavior. “Customized betting” can be integrated into the embodiments in a variety of manners.

Kiosks are devices that offer interactions with customers, clients, and users with a wide range of modular solutions for both retail and online sports gaming. Kiosks can be integrated into the embodiments in a variety of manners.

Business Applications are an integrated suite of tools for customers to manage the everyday activities that drive sales, profit, and growth by creating and delivering actionable insights on performance to help customers to manage the sports gaming. Business Applications can be integrated into the embodiments in a variety of manners.

State-based integration allows for a given sports gambling game to be modified by states in the United States or other countries, based upon the state the player is in, mobile phone, or other geolocation identification means. State-based integration can be integrated into the embodiments in a variety of manners.

Game Configurator allows for configuration of customer operators to have the opportunity to apply various chosen or newly created business rules on the game as well as to parametrize risk management. The Game Configurator can be integrated into the embodiments in a variety of manners.

“Fantasy sports connectors” are software connectors between method steps or system elements in the embodiments that can integrate fantasy sports. Fantasy sports allow a competition in which participants select imaginary teams from among the players in a league and score points according to the actual performance of their players. For example, if a player in fantasy sports is playing at a given real-time sport, odds could be changed in the real-time sports for that player.

Software as a service (or SaaS) is a software delivery and licensing method in which software is accessed online via a subscription rather than bought and installed on individual computers. Software as a service can be integrated into the embodiments in a variety of manners.

Synchronization of screens means synchronizing bets and results between devices, such as TV and mobile, PC, and wearables. Synchronization of screens can be integrated into the embodiments in a variety of manners.

Automatic content recognition (ACR) is an identification technology that recognizes content played on a media device or present in a media file. Devices containing ACR support enable users to quickly obtain additional information about the content they see without any user-based input or search efforts. A short media clip (audio, video, or both) is selected to start the recognition. This clip could be selected from within a media file or recorded by a device. Through algorithms such as fingerprinting, information from the actual perceptual content is taken and compared to a database of reference fingerprints, wherein each reference fingerprint corresponds with a known recorded work. A database may contain metadata about the work and associated information, including complementary media. If the media clip's fingerprint is matched, the identification software returns the corresponding metadata to the client application. For example, during an in-play sports game, a “fumble” could be recognized and at the time stamp of the event, metadata such as “fumble” could be displayed. Automatic content recognition (ACR) can be integrated into the embodiments in a variety of manners.

Joining social media means connecting an in-play sports game bet or result to a social media connection, such as a FACEBOOK® chat interaction. Joining social media can be integrated into the embodiments in a variety of manners.

Augmented reality means a technology that superimposes a computer-generated image on a user's view of the real world, thus providing a composite view. In an example of this invention, a real time view of the game can be seen and a “bet”—which is a computer-generated data point—is placed above the player that is bet on. Augmented reality can be integrated into the embodiments in a variety of manners.

Some embodiments of this disclosure, illustrating all its features, will now be discussed in detail. It can be understood that the embodiments are intended to be open-ended in that an item or items used in the embodiments is not meant to be an exhaustive listing of such item or items or meant to be limited to only the listed item or items.

It can be noted that as used herein and in the appended claims, the singular forms “a,” “an,” and “the” include plural references unless the context clearly dictates otherwise. Although any systems and methods similar or equivalent to those described herein can be used in the practice or testing of embodiments, only some exemplary systems and methods are now described.

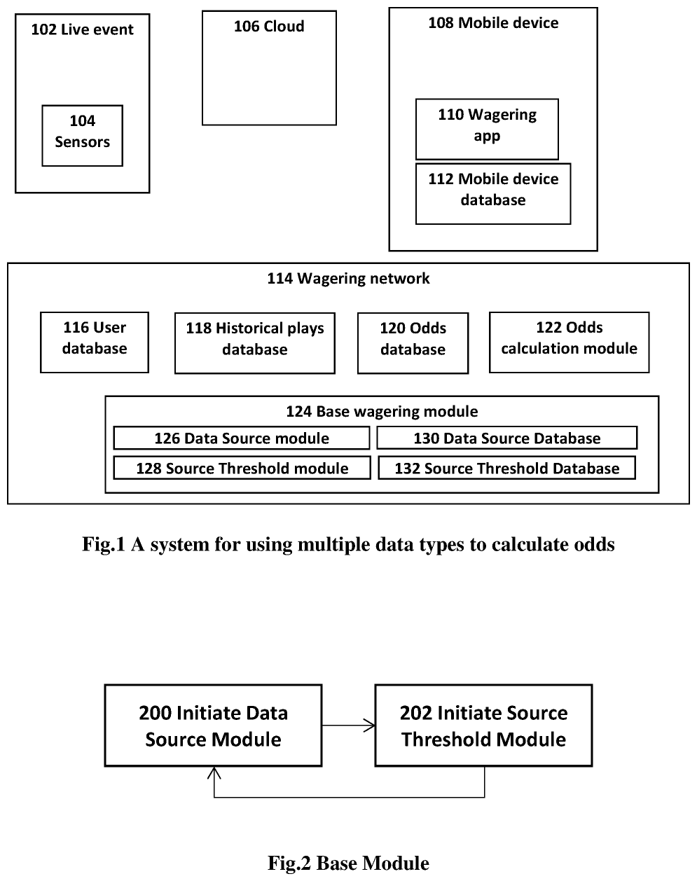

FIG. 1 is a system for using multiple data types to calculate odds. This system may include a live event 102, for example, a sporting event such as a football, basketball, baseball, or hockey game, tennis match, golf tournament, eSports, or digital game, etc. The live event 102 may include some number of actions or plays, upon which a user, bettor, or customer can place a bet or wager, typically through an entity called a sportsbook. There are numerous types of wagers the bettor can make, including, but not limited to, a straight bet, a money line bet, or a bet with a point spread or line that the bettor's team would need to cover if the result of the game with the same as the point spread the user would not cover the spread, but instead the tie is called a push. If the user bets on the favorite, points are given to the opposing side, which is the underdog or longshot. Betting on all favorites is referred to as chalk and is typically applied to round-robin or other tournaments' styles. There are other types of wagers, including, but not limited to, parlays, teasers, and prop bets, which are added games that often allow the user to customize their betting by changing the odds and payouts received on a wager. Certain sportsbooks will allow the bettor to buy points which moves the point spread off the opening line. This increases the price of the bet, sometimes by increasing the juice, vig, or hold that the sportsbook takes. Another type of wager the bettor can make is an over/under, in which the user bets over or under a total for the live event 102, such as the score of an American football game or the run line in a baseball game, or a series of actions in the live event 102. Sportsbooks have several bets they can handle, limiting the number of wagers they can take on either side of a bet before they will move the line or odds off the opening line. Additionally, there are circumstances, such as an injury to an important player like a listed pitcher, in which a sportsbook, casino, or racino may take an available wager off the board. As the line moves, an opportunity may arise for a bettor to bet on both sides at different point spreads to middle, and win, both bets. Sportsbooks will often offer bets on portions of games, such as first-half bets and half-time bets. Additionally, the sportsbook can offer futures bets on live events in the future. Sportsbooks need to offer payment processing services to cash out customers which can be done at kiosks at the live event 102 or at another location.

Further, embodiments may include a plurality of sensors 104 that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors 104 may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball.

Further, embodiments may include a cloud 106 or a communication network that may be a wired and/or wireless network. The communication network, if wireless, may be implemented using communication techniques such as visible light communication (VLC), worldwide interoperability for microwave access (WiMAX), long term evolution (LTE), wireless local area network (WLAN), infrared (IR) communication, public switched telephone network (PSTN), radio waves, or other communication techniques that are known in the art. The communication network may allow ubiquitous access to shared pools of configurable system resources and higher-level services that can be rapidly provisioned with minimal management effort, often over the Internet, and relies on sharing resources to achieve coherence and economies of scale, like a public utility. In contrast, third-party clouds allow organizations to focus on their core businesses instead of expending resources on computer infrastructure and maintenance. The cloud 106 may be communicatively coupled to a peer-to-peer wagering network 114, which may perform real-time analysis on the type of play and the result of the play. The cloud 106 may also be synchronized with game situational data such as the time of the game, the score, location on the field, weather conditions, and the like, which may affect the choice of play utilized. For example, in an exemplary embodiment, the cloud 106 may not receive data gathered from the sensors 104 and may, instead, receive data from an alternative data feed, such as Sports Radar®. This data may be compiled substantially immediately following the completion of any play and may be compared with a variety of team data and league data based on a variety of elements, including the current down, possession, score, time, team, and so forth, as described in various exemplary embodiments herein.

Further, embodiments may include a mobile device 108 such as a computing device, laptop, smartphone, tablet, computer, smart speaker, or I/O devices. I/O devices may be present in the computing device. Input devices may include but are not limited to, keyboards, mice, trackpads, trackballs, touchpads, touch mice, multi-touch touchpads and touch mice, microphones, multi-array microphones, drawing tablets, cameras, single-lens reflex cameras (SLRs), digital SLRs (DSLRs), complementary metal-oxide semiconductor (CMOS) sensors, accelerometers, IR optical sensors, pressure sensors, magnetometer sensors, angular rate sensors, depth sensors, proximity sensors, ambient light sensors, gyroscopic sensors, or other sensors. Output devices may include but are not limited to, video displays, graphical displays, speakers, headphones, inkjet printers, laser printers, or 3D printers. Devices may include, but are not limited to, a combination of multiple input or output devices such as, Microsoft KINECT, Nintendo Wii remote, Nintendo WII U GAMEPAD, or Apple iPhone. Some devices allow gesture recognition inputs by combining input and output devices. Other devices allow for facial recognition, which may be utilized as an input for different purposes such as authentication or other commands. Some devices provide for voice recognition and inputs including, but not limited to, Microsoft KINECT, SIRI for iPhone by Apple, Google Now, or Google Voice Search. Additional user devices have both input and output capabilities including but not limited to, haptic feedback devices, touchscreen displays, or multi-touch displays. Touchscreen, multi-touch displays, touchpads, touch mice, or other touch sensing devices may use different technologies to sense touch, including but not limited to, capacitive, surface capacitive, projected capacitive touch (PCT), in-cell capacitive, resistive, IR, waveguide, dispersive signal touch (DST), in-cell optical, surface acoustic wave (SAW), bending wave touch (BWT), or force-based sensing technologies. Some multi-touch devices may allow two or more contact points with the surface, allowing advanced functionality including, but not limited to, pinch, spread, rotate, scroll, or other gestures. Some touchscreen devices, including but not limited to, Microsoft PIXELSENSE or Multi-Touch Collaboration Wall, may have larger surfaces, such as on a table-top or on a wall, and may also interact with other electronic devices. Some I/O devices, display devices, or groups of devices may be augmented reality devices. An I/O controller may control one or more I/O devices, such as a keyboard and a pointing device, or a mouse or optical pen. Furthermore, an I/O device may also contain storage and/or an installation medium for the computing device. In some embodiments, the computing device may include USB connections (not shown) to receive handheld USB storage devices. In further embodiments, an I/O device may be a bridge between the system bus and an external communication bus, e.g., USB, SCSI, FireWire, Ethernet, Gigabit Ethernet, Fiber Channel, or Thunderbolt buses. In some embodiments, the mobile device 108 could be an optional component and would be utilized in a situation where a paired wearable device employs the mobile device 108 for additional memory or computing power or connection to the internet.

Further, embodiments may include a wagering software application or a wagering app 110, which is a program that enables the user to place bets on individual plays in the live event 102, streams audio and video from the live event 102, and features the available wagers from the live event 102 on the mobile device 108. The wagering app 110 allows the user to interact with the wagering network 114 to place bets and provide payment/receive funds based on wager outcomes.

Further, embodiments may include a mobile device database 112 that may store some or all the user's data, the live event 102, or the user's interaction with the wagering network 114.

Further, embodiments may include the wagering network 114, which may perform real-time analysis on the type of play and the result of a play or action. The wagering network 114 (or the cloud 106) may also be synchronized with game situational data, such as the time of the game, the score, location on the field, weather conditions, and the like, which may affect the choice of play utilized. For example, in an exemplary embodiment, the wagering network 114 may not receive data gathered from the sensors 104 and may, instead, receive data from an alternative data feed, such as SportsRadar®. This data may be provided substantially immediately following the completion of any play and may be compared with a variety of team data and league data based on a variety of elements, including the current down, possession, score, time, team, and so forth, as described in various exemplary embodiments herein. The wagering network 114 can offer several SaaS managed services such as user interface service, risk management service, compliance, pricing and trading service, IT support of the technology platform, business applications, game configuration, state-based integration, fantasy sports connection, integration to allow the joining of social media, or marketing support services that can deliver engaging promotions to the user.

Further, embodiments may include a user database 116, which may contain data relevant to all users of the wagering network 114 and may include, but is not limited to, a user ID, a device identifier, a paired device identifier, wagering history, or wallet information for the user. The user database 116 may also contain a list of user account records associated with respective user IDs. For example, a user account record may include, but is not limited to, information such as user interests, user personal details such as age, mobile number, etc., previously played sporting events, highest wager, favorite sporting event, or current user balance and standings. In addition, the user database 116 may contain betting lines and search queries. The user database 116 may be searched based on a search criterion received from the user. Each betting line may include but is not limited to, a plurality of betting attributes such as at least one of the following: the live event 102, a team, a player, an amount of wager, etc. The user database 116 may include, but is not limited to, information related to all the users involved in the live event 102. In one exemplary embodiment, the user database 116 may include information for generating a user authenticity report and a wagering verification report. Further, the user database 116 may be used to store user statistics like, but not limited to, the retention period for a particular user, frequency of wagers placed by a particular user, the average amount of wager placed by each user, etc.

Further, embodiments may include a historical plays database 118 that may contain play data for the type of sport being played in the live event 102. For example, in American Football, for optimal odds calculation, the historical play data may include metadata about the historical plays, such as time, location, weather, previous plays, opponent, physiological data, etc.

Further, embodiments may utilize an odds database 120—that may contain the odds calculated by an odds calculation module 122—to display the odds on the user's mobile device 108 and take bets from the user through the mobile device wagering app 110.

Further, embodiments may include the odds calculation module 122, which may utilize historical play data to calculate odds for in-play wagers.

Further, embodiments may include a base module 124, which may initiate the data source module 126 and the source threshold module 128. The data source module 126 may connect to the live event 102. For example, the data source module 126 may connect to the plurality of sensors 104 available at the live event 102. The data source module 126 may receive the first available data source. Then the data source module 126 may store the data source in the data source database 130. The data source module may determine if there is another available data source from the live event 102. If another data source is available, the data source module 126 may receive the next available data source. If no other data sources are available, then the data source module 126 may return to the base module 124. The source threshold module 128 may extract the first data source from the data source database 130. The source threshold module 128 may compare the extracted data source to the data threshold database 132. The source threshold module 128 may determine if the data source meets the requirements stored in the data threshold database 132. If it is determined that the data source meets the requirements in the data threshold database 132, then the source threshold module 128 may send the data source to the odds calculation module 122 to determine the odds for the upcoming event. If it is determined that the data source does not meet the requirements stored in the data threshold database 132, then the source threshold module 128 may extract the next data source from the data source database 130.

Further, embodiments may include a data source module 126. The process may begin with the data source module 126 being initiated by the base module 124. Then the data source module 126 may connect to the live event 102. For example, the data source module 126 may connect to the plurality of sensors 104 available at the live event 102. The data source module 126 may receive the first available data source. For example, the data source module 126 may receive the data from the first available sensor 104 located at the live event 102. Then the data source module 126 may store the data source in the data source database 130. For example, the data source module 126 may store the type of sources, such as a camera, sensor, data feed, or various other sensors 104, the source number, the type of event from which the data source is located, and the various parameters of the data source, such as the number of players, the names of players, the score to the event, the time of the event, etc. The data source module 126 may determine if there is another available data source from the live event 102. For example, there may be a plurality of data sources at the live event 102, such as multiple cameras, multiple sensors, multiple types of data feeds, video feeds, audio feeds, etc. If there is another data source, the data source module 126 may receive the next available data source. If there are no other data sources available, then the data source module 126 may return to the base module 124.

Further, embodiments may include a source threshold module 128, which may extract the first data source from the data source database 130. For example, the source threshold module 128 may extract a camera from the data source database 130, which may contain the parameters of the number of players on the field, the score of the event, and the time of the event. The source threshold module 128 may compare the extracted data source to the data threshold database 132. For example, the source threshold module 128 may compare the event from the data source to the event in the data threshold database 132, such as baseball, and then compare the parameters of the extracted camera data source, such as the number of players on the field, the score of the event and the time of the event, to the requirements for a baseball event stored in data threshold database 132, such as the data source is required to have ten players on the field for baseball or the data source is required to have the score and the time of the event. The source threshold module 128 may determine if the data source meets the requirements stored in the data threshold database 132. For example, assuming the extracted camera data source parameters meet the thresholds stored in the data threshold database 132, the camera data source may be sent to the odds calculation module 122 to determine the wager odds. Another example may be if the extracted data source did not meet the requirements, then the source threshold module 128 may select the next data source stored in the data source database 130 to determine if the next data source meets the thresholds stored in the data threshold database 132. In some embodiments, a plurality or all the requirements may need to be reached or exceeded for the data source to be sent to the odds calculation module 122. Only one requirement may need to be reached or exceeded in some embodiments for the data source to be sent to the odds calculation module 122. If the data source meets the requirements in the data threshold database 132, then the source threshold module 128 may send the data source to the odds calculation module 122 to determine the odds for the upcoming event. For example, the extracted camera data source stored in the data source database 130 may be sent to the odds calculation module 122 to be used as the data source to calculate the wager odds. There may be a plurality of data sources sent to the odds calculation module 122 to calculate the wager odds in some embodiments. For example, a camera may be used to calculate the odds for the upcoming result of a pitch, such as a strike or a ball, and data feed may be used to determine the odds of the wager for the upcoming result of a hit such as a single, double, triple, home run, etc. If the data source does not meet the requirements stored in the data threshold database 132, then the source threshold module 128 may extract the next data source from the data source database 130.

Further, embodiments may include a data source database 130. The data source database 130 may contain a list of available data sources from the live event 102, including cameras, video feed, audio feed, sensors on the field, sensors on the players, sensors on the officials, referees, or umpire's data feed such as SportsRadar or Trackman. In some embodiments, the data sources may include a plurality of sensors that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. The data source database 130 may also contain a source number, the event for which the data source is collecting data, a source identification (ID), the type of data source, and various parameters that list the details of what the data source provides. In some embodiments, the parameters may be the players are in the live event 102, how many players are currently involved in an upcoming play, the score of the live event 102, the time in the live event 102, actions performed in the live event 102, for example in baseball, a type of pitch thrown, the location of the pitch, if the pitch was a ball or strike, a hit such as a single, double, etc., a stolen base, etc. In some embodiments, the data source database 130 may include the wagering market associated with the parameter. For example, if the parameter is for hits in a baseball game, then the associated wager market may be the odds for the batter to hit a single, double, triple, home run, etc. Another example may if the parameter is for the pitches thrown and the resulting outcome such as a strike or ball, then the associated wager market may be for the odds on the results of a pitch.

Further, embodiments may include a data threshold database 132. The data threshold database 132 may contain a list of thresholds that the available data sources stored in the data source database 130 may be compared to during the process described in the source threshold module 128. The data threshold database 132 may contain the type of event, such as baseball, football, basketball, hockey, etc., and the requirements for the data source such as the number of players in the field of play, the names of players, the score of the event, the time in the event, and “N” representing an infinite number of potential requirements. In some embodiments, the requirements may include cameras, video feed, audio feed, sensors on the field, sensors on the players, sensors on the officials, referees, or umpires, a data feed such as SportsRadar or Trackman. In some embodiments, the requirements may include a plurality of sensors such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, a plurality or all of the requirements may need to be reached or exceeded for the data source to be sent to the odds calculation module 122. Only one requirement may need to be reached or exceeded in some embodiments for the data source to be sent to the odds calculation module 122. In some embodiments, the requirements may be based on a specific wager market. For example, if the wagering market is for the outcome of a hit in a baseball game, such as single, double, triple, home run, etc., then the data source may only be required to have the data for the result of a hit. Another example may be if the wagering market is for the outcome of a pitch, such as a strike or a ball, then the data source may only be required to contain the outcome of a pitch.

FIG. 2 illustrates the base module 124. The process may begin with the base module 124 initiating, at step 200, the data source module 126. For example, the data source module 126 may connect to the live event 102. For example, the data source module 126 may connect to the plurality of sensors 104 available at the live event 102. The data source module 126 may receive the first available data source. For example, the data source module 126 may receive the data from the first available sensor 104 located at the live event 102. Then the data source module 126 may store the data source in the data source database 130. For example, the data source module 126 may store the type of sources, such as a camera, sensor, data feed, or various other sensors 104, the source number, the type of event that the data source is located at, and the various parameters of the data source, such as the number of players, the names of players, the score to the event, the time of the event, etc. The data source module 126 may determine if there is another available data source from the live event 102. For example, there may be a plurality of data sources at the live event 102, such as multiple cameras, multiple sensors, multiple types of data feeds, video feeds, audio feeds, etc. If there is another data source, the data source module 126 may receive the next available data source. If i there are no other data sources available, then the data source module 126 may return to the base module 124. Then the base module 124 may initiate, at step 202, the source threshold module 128. For example, the source threshold module 128 may extract the first data source from the data source database 130. For example, the source threshold module 128 may extract a camera from the data source database 130, which may contain the parameters of the number of players on the field, the score of the event, and the time of the event. The source threshold module 128 may compare the extracted data source to the data threshold database 132. For example, the source threshold module 128 may compare the event from the data source to the event in the data threshold database 132, such as baseball, and then compare the parameters of the extracted camera data source, such as the number of players on the field, the score of the event and the time of the event, to the requirements for a baseball event stored in data threshold database 132, such as the data source is required to have ten players on the field for baseball or the data source is required to have the score and the time of the event. The source threshold module 128 may determine if the data source meets the requirements stored in the data threshold database 132. For example, assuming the extracted camera data source parameters meet the thresholds stored in the data threshold database 132, the camera data source may be sent to the odds calculation module 122 to determine the wager odds. Another example may be if the extracted data source did not meet the requirements, then the source threshold module 128 may select the next data source stored in the data source database 130 to determine if the next data source meets the thresholds stored in the data threshold database 132. In some embodiments, a plurality or all of the requirements may need to be reached or exceeded for the data source to be sent to the odds calculation module 122. Only one requirement may need to be reached or exceeded in some embodiments for the data source to be sent to the odds calculation module 122. If the data source meets the requirements in the data threshold database 132, then the source threshold module 128 may send the data source to the odds calculation module 122 to determine the odds for the upcoming event. For example, the extracted camera data source stored in the data source database 130 may be sent to the odds calculation module 122 to be used as the data source to calculate the wager odds. There may be a plurality of data sources sent to the odds calculation module 122 to calculate the wager odds in some embodiments. For example, a camera may be used to calculate the odds for the upcoming result of a pitch, such as a strike or a ball, and data feed may be used to determine the odds of the wager for the upcoming result of a hit such as a single, double, triple, home run, etc. If the data source does not meet the requirements stored in the data threshold database 132, then the source threshold module 128 may extract the next data source from the data source database 130.

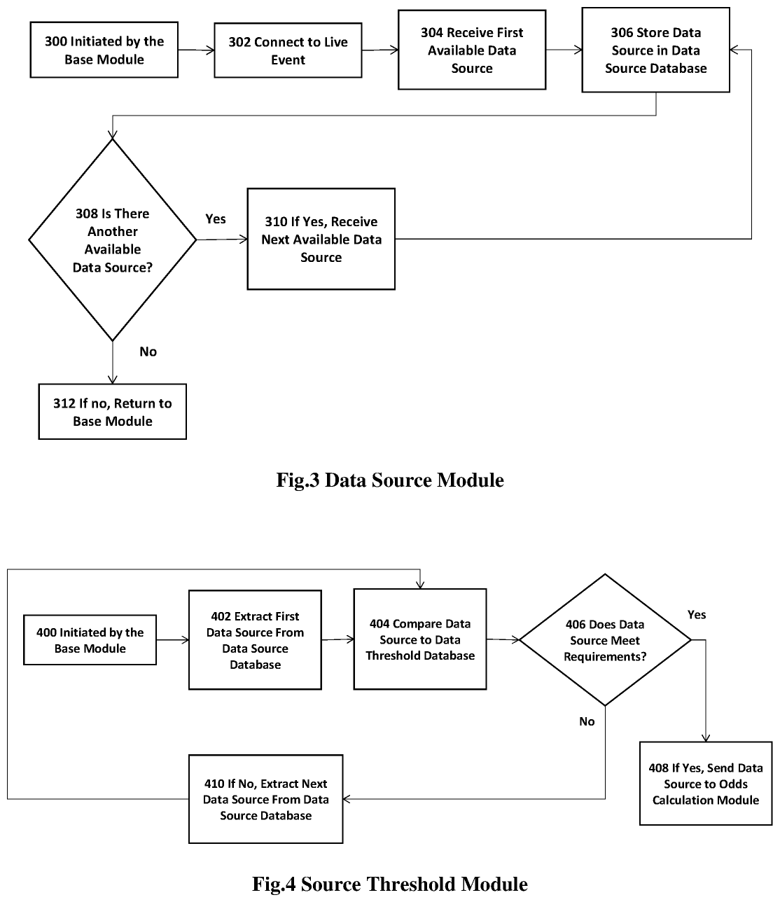

FIG. 3 illustrates the data source module 126. The process may begin with the data source module 126 being initiated, at step 300, by the base module 124. Then the data source module 126 may connect, at step 302, to the live event 102. For example, the data source module 126 may connect to the plurality of sensors 104 available at the live event 102. The data source module 126 may receive, at step 304, the first available data source. For example, the data source module 126 may be receiving the data from the first available sensor 104 located at the live event 102. Then the data source module 126 may store, at step 306, the data source in the data source database 130. For example, the data source module 126 may store the type of sources, such as a camera, sensor, data feed, or various other sensors 104, the source number, the type of event that the data source is located at, and the various parameters of the data source, such as the number of players, the names of players, the score to the event, the time of the event, etc. The data source module 126 may determine, at step 308, if another data source is available from the live event 102. For example, there may be a plurality of data sources at the live event 102, such as multiple cameras, multiple sensors, multiple types of data feeds, video feeds, audio feeds, etc. If there is another data source, the data source module 126 may receive, at step 310, the next available data source and return to step 306. If there are no other data sources available, then the data source module 126 may return, at step 312, to the base module 124.

FIG. 4 illustrates the source threshold module 128. The process may begin with the source threshold module 128 being initiated, at step 400, by the base module 124. Then the source threshold module 128 may extract, at step 402, the first data source from the data source database 130. For example, the source threshold module 128 may extract a camera from the data source database 130, which may contain the parameters of the number of players on the field, the score of the event, and the time of the event. The source threshold module 128 may compare, at step 404, the extracted data source to the data threshold database 132. For example, the source threshold module 128 may compare the event from the data source to the event in the data threshold database 132, such as baseball, and then may compare the parameters of the extracted camera data source, such as the number of players on the field, the score of the event and the time of the event, to the requirements for a baseball event stored in data threshold database 132, such as the data source is required to have ten players on the field for baseball, the data source is required to have the score and the time of the event. The source threshold module 128 may determine, at step 406, if the data source meets the requirements stored in the data threshold database 132. For example, assuming the extracted camera data source parameters meets the thresholds stored in the data threshold database, the camera data source may be sent to the odds calculation module 122 to be used to determine the wager odds. Another example may be if the extracted data source did not meet the requirements, then the source threshold module 128 may select the next data source stored in the data source database 130 to determine if the next data source meets the thresholds stored in the data threshold database 132. In some embodiments, a plurality or all of the requirements may need to be reached or exceeded for the data source to be sent to the odds calculation module 122. Only one requirement may need to be reached or exceeded in some embodiments for the data source to be sent to the odds calculation module 122. If the data source meets the requirements in the data threshold database 132, then the source threshold module 128 may send, at step 408, the data source to the odds calculation module 122 to determine the odds for the upcoming event. For example, the extracted camera data source stored in the data source database 130 may be sent to the odds calculation module 122 to be used as the data source to calculate the wager odds. There may be a plurality of data sources sent to the odds calculation module 122 to calculate the wager odds in some embodiments. For example, a camera may be used to calculate the odds for the upcoming result of a pitch, such as a strike or a ball, and data feed may be used to determine the odds of the wager for the upcoming result of a hit such as a single, double, triple, home run, etc. If the data source does not meet the requirements stored in the data threshold database 132, then the source threshold module 128 may extract, at step 410, the next data source from the data source database 130 and return to step 404.

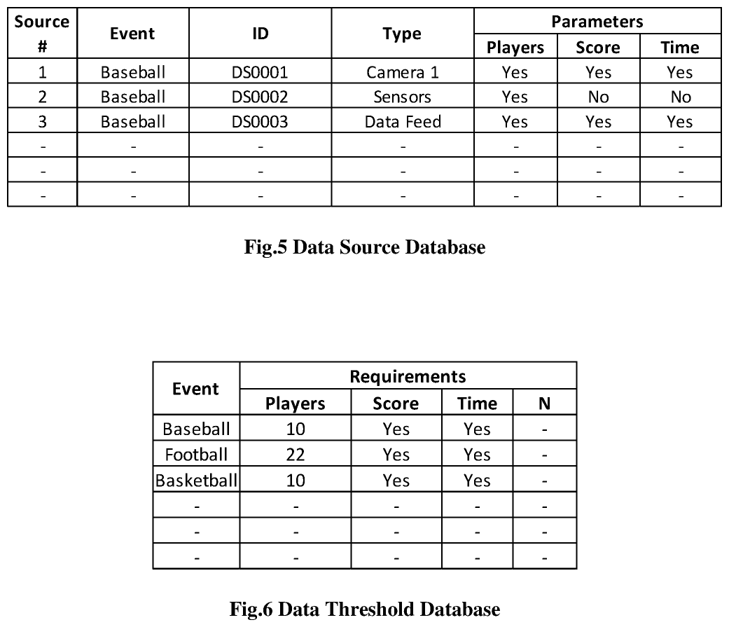

FIG. 5 illustrates the data source database 130. The data source database 130 may contain a list of available data sources from a live event 102, including cameras, video feed, audio feed, sensors on the field, sensors on the players, sensors on the officials, referees, or umpires, a data feed such as SportsRadar or Trackman. In some embodiments, the data sources may include a plurality of sensors that may be used such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. The data source database 130 may also contain a source number, the event for which the data source is collecting data, a source identification (ID), the type of data source, and various parameters that list the details of what the data source provides. In some embodiments, the parameters may be the players in the live event 102, how many players are currently involved in an upcoming play, the score of the live event 102, the time in the live event 102, actions performed in the live event 102, for example in baseball a type of pitch thrown, the location of the pitch, if the pitch was a ball or strike, a hit such as a single, double, etc., a stolen base, etc. In some embodiments, the data source database 130 may include the wagering market associated with the parameter. For example, if the parameter is for hits in a baseball game, then the associated wager market may be the odds for the batter to hit a single, double, triple, home run, etc. Another example may if the parameter is for the pitches thrown and the resulting outcome such as a strike or ball, then the associated wager market may be for the odds on the results of a pitch.

FIG. 6 illustrates the data threshold database 132. The data threshold database 132 may contain a list of thresholds that the available data sources stored in the data source database 130 are compared to during the process described in the source threshold module 128. The data threshold database 132 may contain the type of event, such as baseball, football, basketball, hockey, etc., and the requirements for the data source such as the number of players in the field of play, the names of players, the score of the event, the time in the event, and “N” representing an infinite number of potential requirements. In some embodiments, the requirements may include cameras, video feed, audio feed, sensors on the field, sensors on the players, sensors on the officials, referees, or umpires, a data feed such as SportsRadar or Trackman. In some embodiments, the requirements may include a plurality of sensors such as motion, temperature, or humidity sensors, optical sensors, and cameras such as an RGB-D camera which is a digital camera capable of capturing color (RGB) and depth information for every pixel in an image, microphones, radiofrequency receivers, thermal imagers, radar devices, lidar devices, ultrasound devices, speakers, wearable devices, etc. Also, the plurality of sensors may include but are not limited to, tracking devices, such as RFID tags, GPS chips, or other such devices embedded on uniforms, in equipment, in the field of play and boundaries of the field of play, or on other markers in the field of play. Imaging devices may also be used as tracking devices, such as player tracking, which provide statistical information through real-time X, Y positioning of players and X, Y, Z positioning of the ball. In some embodiments, a plurality or all of the requirements may need to be reached or exceeded for the data source to be sent to the odds calculation module 122. Only one requirement may need to be reached or exceeded in some embodiments for the data source to be sent to the odds calculation module 122. In some embodiments, the requirements may be based on a specific wager market. For example, if the wagering market is for the outcome of a hit in a baseball game, such as single, double, triple, home run, etc., then the data source may only be required to have the data for the result of a hit. Another example may be if the wagering market is for the outcome of a pitch, such as a strike or a ball, then the data source may only be required to contain the outcome of a pitch.

The foregoing description and accompanying figures illustrate the principles, preferred embodiments, and modes of operation of the invention. However, the invention should not be construed as being limited to the embodiments discussed above. Additional variations of the embodiments discussed above will be appreciated by those skilled in the art.

Therefore, the above-described embodiments should be regarded as illustrative rather than restrictive. Accordingly, it should be appreciated that variations to those embodiments can be made by those skilled in the art without departing from the scope of the invention as defined by the following claims.

1. A method of utilizing multiple data sources to calculate odds on a wagering network, comprising:
collecting the multiple data sources from a plurality of sensors at a live event;
connecting the multiple data sources to data source database, wherein the data source database stores respective data parameters for each data source of the multiple data sources corresponding to at least a type of the live event;
extracting, with the data threshold database, each data source from the data source database, wherein the data threshold database stores threshold requirements that respectively correspond to each type of the live event;
comparing, with the source threshold module, data source parameters from each data source to threshold requirements matching the type of live event in the data threshold database;
determining a subset of data sources to send to an odds calculation module, wherein each data source having data source parameters not matching the threshold requirements is excluded from the subset, each data source having data source parameters meeting or exceeding the threshold requirements is included in the subset, and the odds calculation module uses real-time analysis of the subset of data sources to provide a real-time change in the calculated odds.

2. The method of claim 1, wherein the plurality of sensors further comprise at least one of a motion sensor, a temperature sensor, a humidity sensor, an optical sensor, a camera, a microphone, a radiofrequency receiver, a thermal imager, a radar device, a lidar device, an ultrasound device, a speaker, a wearable device, a tracking device, an RFID tag, a GPS chip, or a field marker.

3. The method of claim 1, wherein the multiple data sources further comprise at least one of a camera, a video feed, an audio feed, a sensor on a field, a sensor on a player, a sensor on an official, or a data feed.

4. The method of claim 1, wherein the data source parameters further comprise at least a player in the live event, a player currently involved in an upcoming play, a score of the live event, a time in the live event, or actions performed in the live event.

5. The method of claim 4, wherein the actions performed in the live event further comprise a type of play, a location of the play, or a result of the play.

6. The method of claim 1, wherein the threshold requirements further comprise at least an amount of players in a field of play, a name of a player, a score of the live event, and a time in the live event.

7. A system of utilizing multiple data sources to calculate odds on a wagering network, comprising:
a base module;
a data source module configured to connect to the multiple data sources from a plurality of sensors at a live event, connect the multiple data sources to a data source database that is configured to store respective data parameters for each data source of the multiple data sources corresponding to at least a type of the live event, wherein a data threshold database is configured to extract each data source from the data source database and store threshold requirements that respectively correspond to each type of the live event; and
a source threshold module configured to compare data source parameters from each data source to threshold requirements matching the type of live event, and determine a subset of data sources to send to an odds calculation module, wherein each data source having data source parameters not matching the threshold requirements is excluded from the subset, and each data source having data source parameters meeting or exceeding the threshold requirements is included in the subset, and the odds calculation module uses real-time analysis of the subset of data sources to provide a real-time change in the calculated odds.

8. The system of claim 7, wherein the threshold requirements in the data threshold database are further configured to be at least an amount of players in a field of play, a name of a player, a score of the live event, and a time in the live event.
